(19) United States
(12) Patent Application Publication
(10) Pub. No.: US 2024/0246719 A1
(43) Pub. Date: Jul. 25, 2024

(54) Container With Barrier Member

(71) Applicant: Graphic Packaging International, LLC, Atlanta, GA (US)

(72) Inventor: Simon Holka, Staffanstorp (SE)

(21) Appl. No.: 18/418,719

(22) Filed: Jan. 22, 2024

Related U.S. Application Data
(60) Provisional application No. 63/440,559, filed on Jan. 23, 2023.

(51) Int. Cl. B65D 5/54; B65D 5/02; B65D 5/04; B65D 5/498; B65D 5/50; B65D 17/28

(52) U.S. Cl. CPC B65D 5/5425; B65D 5/04; B65D 5/5002; B65D 17/4014; B65D 5/0209; B65D 5/48048

(57) ABSTRACT

A container for holding at least one article includes a body extending at least partially around an interior of the container includes a reclosable lid engaged with the body, the reclosable lid repositionable between an open position, in which the reclosable lid is moved away from the interior of the container, and a closed position, in which the reclosable lid at least partially overlies the interior of the container, a closed bottom engaged with the body, and a barrier member positioned in the interior of the container, the barrier member includes a central portion at least partially separably connected to a marginal portion, the marginal portion attached to the body.

### CROSS-REFERENCE TO RELATED APPLICATION

This application claims priority to U.S. Provisional Patent Application No. 63/440,559, filed on Jan. 23, 2023.

### INCORPORATION BY REFERENCE

The disclosure of U.S. Provisional Patent Application No. 63/440,559, filed on Jan. 23, 2023, is hereby incorporated by reference for all purposes as if set forth herein in its entirety.

### BACKGROUND

The present disclosure generally relates to containers for holding one or more articles. In some embodiments, the present disclosure relates to containers having at least one barrier member.

### SUMMARY

According to one aspect, the disclosure is generally directed to a container for holding at least one article, the container comprising a body extending at least partially around an interior of the container, a reclosable lid engaged with the body, the reclosable lid repositionable between an open position, in which the reclosable lid is moved away from the interior of the container, and a closed position, in which the reclosable lid at least partially overlies the interior of the container, a closed bottom engaged with the body, and a barrier member positioned in the interior of the container, the barrier member comprising a central portion at least partially separably connected to a marginal portion, the marginal portion attached to the body.

According to another aspect, the disclosure is generally directed to a combination of blanks for forming a container for holding at least one article, the combination of blanks comprising a body blank for forming a body extending at least partially around an interior of the container formed from the combination of blanks, a lid blank for forming reclosable lid engaged with the body when the container is formed from the combination of blanks such that the reclosable lid repositionable between an open position, in which the reclosable lid is moved away from the interior of the container formed from the combination of blanks, and a closed position, in which the reclosable lid at least partially overlies the interior of the container formed from the combination of blanks, a bottom blank for forming a closed bottom engaged with the body of the container formed from the combination of blanks, and a barrier blank positioned in the interior of the container formed from the combination of blanks, the barrier blank comprising a central portion at least partially separably connected to a marginal portion, the marginal portion for being attached to the body of the container formed from the combination of blanks.

According to another aspect, the disclosure is generally directed to a method of forming a container for holding at least one article, the method comprising obtaining a body blank, obtaining a lid blank, obtaining a bottom blank, obtaining a barrier blank, the barrier blank comprising a central portion at least partially separably connected to a marginal portion, forming a body of the container from the body blank such that the body extends at least partially around an interior of the container, forming a reclosable lid from the lid blank such that the reclosable lid is engaged with the body, the reclosable lid repositionable between an open position, in which the reclosable lid is moved away from the interior of the container, and a closed position, in which the reclosable lid at least partially overlies the interior of the container, forming a closed bottom from the bottom blank such that the closed bottom is engaged with the body of the container, and attaching the marginal portion of the barrier blank to the body of the container to form a barrier member.

Those skilled in the art will appreciate the above-stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a body blank used to form a body of a container according to an exemplary embodiment of the disclosure.

FIG. 2 is a plan view of an exterior surface of a lid blank for forming a lid or top end of a container according to an exemplary embodiment of the disclosure.

FIG. 3 is a plan view of an exterior surface of a bottom blank for forming a bottom of a container according to an exemplary embodiment of the disclosure.

FIG. 4A is a plan view of an exterior surface of a barrier blank for forming a barrier member of a container according to an exemplary embodiment of the disclosure.

FIG. 4B is a plan view of the interior surface of the barrier blank of FIG. 4A.

FIGS. 5A-5C are sequential perspective views of a formation of a container according to an exemplary embodiment of the disclosure.

FIGS. 6 and 7 are perspective views illustrating accessing an interior of the container formed from the blanks of FIGS. 1-4B according to an exemplary embodiment of the disclosure.

FIGS. 8A and 8B are plan views of a respective exterior surface and interior surface of a barrier blank for forming a barrier member according to another exemplary embodiment of the disclosure.

FIGS. 9A and 9B are plan views of a respective exterior surface and interior surface of a barrier blank for forming a barrier member according to another exemplary embodiment of the disclosure.

FIGS. 10A and 10B are plan views of a respective exterior surface and interior surface of a barrier blank for forming a barrier member according to another exemplary embodiment of the disclosure.

Corresponding parts are designated by corresponding reference numbers throughout the drawings.

### DETAILED DESCRIPTION

Containers according to the present disclosure can accommodate articles of numerous different shapes. For the purpose of illustration and not for the purpose of limiting the scope of the disclosure, the following detailed description describes articles such as food products. Such food products can be provided in discrete or granular portions, e.g., as in snacks, for example, candy, gum, chocolate, granola, cereal, nuts, trail mix, raisins, dried fruit, etc. It will be understood that a different type of article such as a different type of food product or different type of article, e.g., powdered food products or powdered articles, can be held in containers according to the present disclosure without departing from the disclosure. It will be further understood that articles other than food products can be held in containers according to the present disclosure.

In this specification, the terms “lower,” “bottom,” “upper,” and “top” indicate orientations determined in relation to fully erected and upright containers. As described herein, containers can be formed from blanks by overlapping multiple panels, portions, and/or end flaps. Such panels, portions and/or end flaps may be designated herein in terms relative to one another, e.g., “first”, “second”, “third”, etc., in sequential or non-sequential reference, without departing from the disclosure.

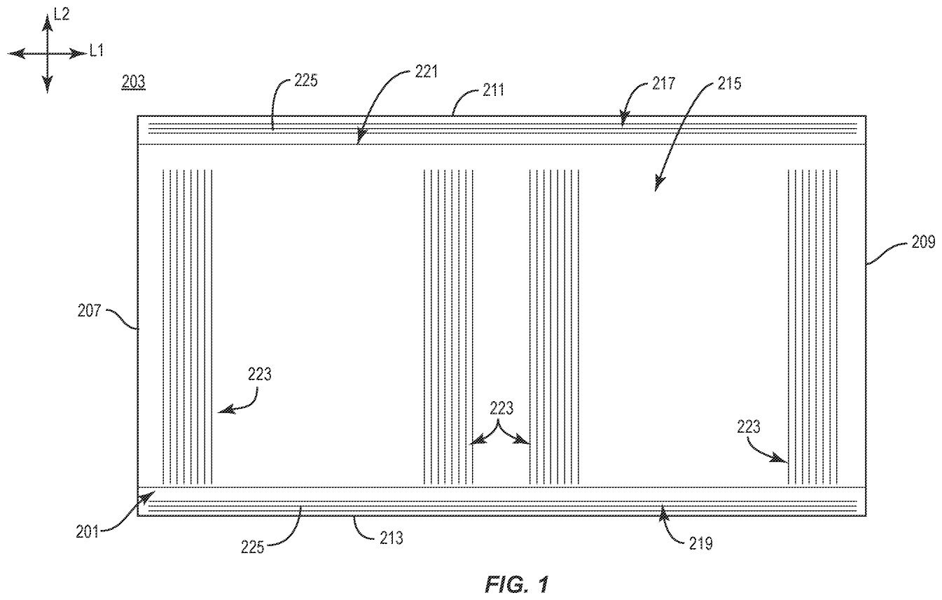

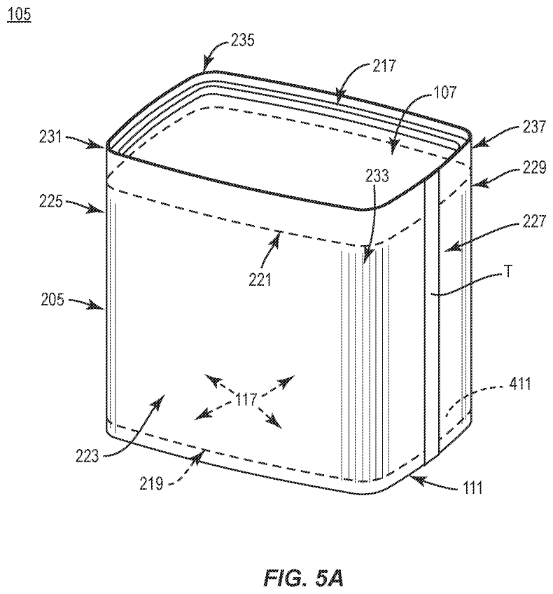

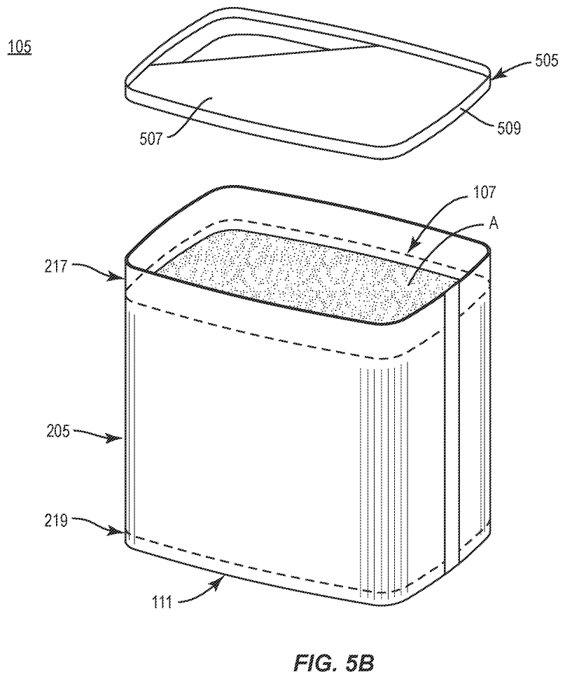

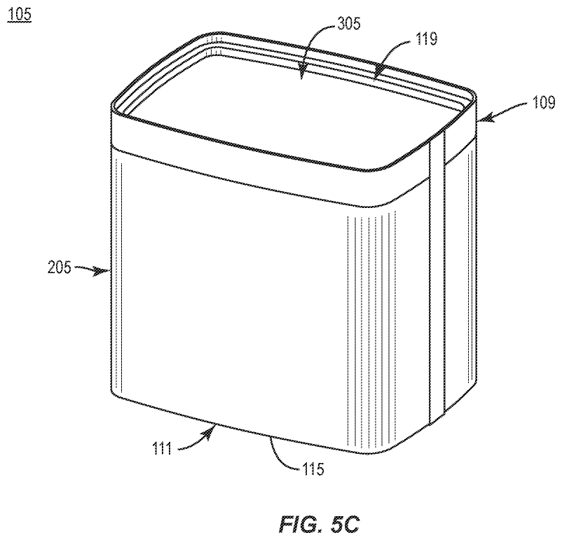

FIGS. 1-4B are plan views of a series of blanks used to form components that assemble to form a container 105 (FIG. 5C) according to an exemplary embodiment of the present disclosure. In this regard, in some embodiment the container 105 can be considered an assembly or system of a plurality of components.

Referring to FIG. 1, a plan view of an exterior surface 201 of a body blank 203 for forming a body 205 of the container 105 is illustrated. As described herein, the body 205 is arranged to extend at least partially around an interior 107 of the container 105.

As shown, the body blank 203 can have a longitudinal axis L1 and a lateral axis L2. In some embodiments, the axes L1, L2 can be transposed. In the illustrated embodiment, the body blank 203 can have a generally rectangular configuration with a pair of opposite lateral free edges 207, 209 and a pair of opposite longitudinal free edges 211, 213 extending from a respective endpoint of the free edge 207 to a respective endpoint of the free edge 209.

The body blank 203 can also include a body forming portion 215 defined along a central portion of the body blank 203, a first or top end or lid forming portion 217 defined at an upper peripheral portion/upper marginal portion of the body blank 203, and a second or bottom end forming portion 219 defined at a lower peripheral portion/lower marginal portion of the body blank 203.

As shown, the lid forming portion 217 of the body blank 203 can be at least partially separably connected to the body forming portion 215 and at least partially foldably connected to the body forming portion 215 at a longitudinal line of weakening 221 that can include at least one tear segment and at least one fold line segment.

With continued reference to FIG. 1, the body blank 203 can include a multiple pluralities of lateral lines of weakening 223 that can facilitate the formation of curved corners when the body 205 is formed from the body blank 203, as described further herein.

The body blank 203 can also include one or more pluralities of longitudinal lines of weakening 225 extending therealong. In the illustrated embodiment, the body blank 203 can include a plurality of longitudinal lines of weakening 225 extending across the lid forming portion 217 and another plurality of longitudinal lines of weakening 225 extending along the body forming portion 219. As described further herein, the lines of weakening 225 can facilitate formation of the body 205 from the body blank 203.

In some embodiments, the body blank 203 can be comprised of one or more paperboard materials made predominantly from cellulose fibers or paper fibers. The material may be provided in the form of a continuous web or may be provided as individual sheets of material. The paperboard material may be a single ply or multi ply material and may be a laminate comprising one or more reinforcing, moisture resistant non-cellulosic layers of materials such as films and coatings, metal foil, etc. The paperboard material may be coated, printed, embossed, etc. and may comprise fillers, pigments, binders and other additives as known in the art. In some embodiments, the paperboard material can be devoid of polymeric and/or metallic materials.

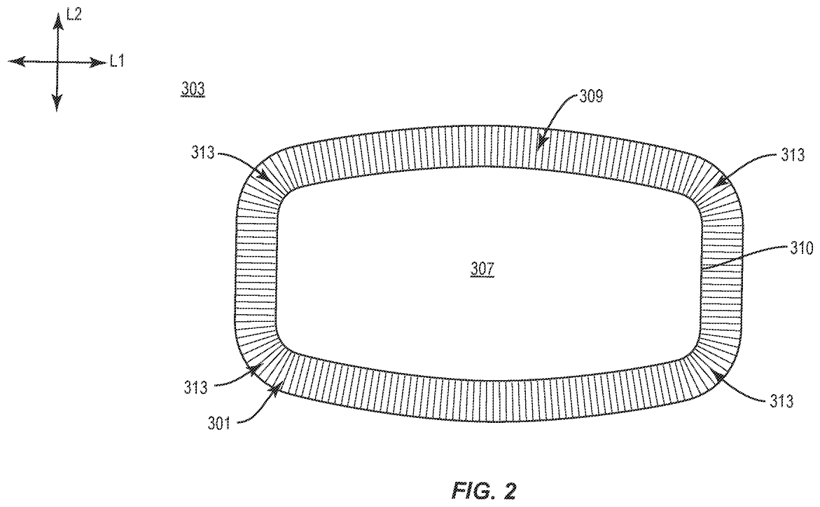

Turning to FIG. 2, the exterior surface 301 of a lid blank 303 for at least partially forming a reclosable lid 109 of the container 105 is illustrated. As shown, the lid blank 303 can have the longitudinal axis L1 and the lateral axis L2, and can include a central portion 307 and a marginal portion 309 extending to the peripheral edges of the lid blank 303.

In some embodiments, the marginal portion 309 of the lid blank 303 can be at least partially foldably connected to the central portion 307 at a generally rounded rectangular/elliptical fold line 310. In other embodiments, one or more foldable connections between the marginal portion 309 of the lid blank 303 and the central portion 307 of the lid blank 303 can be formed upon formation of the lid 109 of the container 105, as described further herein.

As also shown, the lid blank 303 can include multiple pluralities of oblique and/or curved lines of weakening 313 arranged along corner portions of the lid blank 303. As described further herein, the lines of weakening 313 can facilitate formation of the lid 109/container 105.

It will be understood that the lid blank 303 can be formed from one or more materials that are the same or similar to those that form the body blank 203 as described above, e.g., paperboard materials.

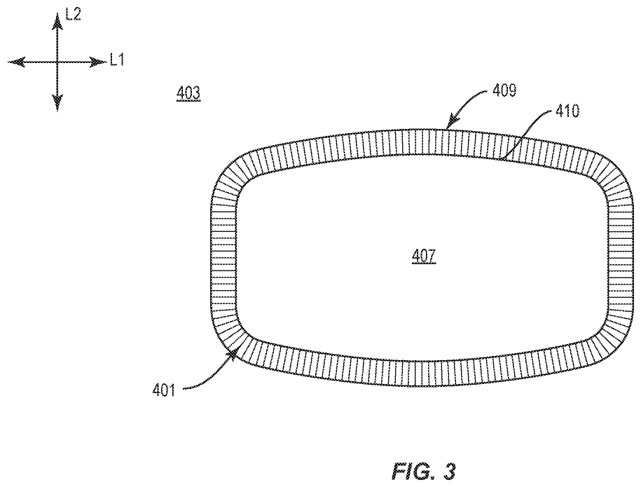

Turning to FIG. 3, the exterior surface 401 of a bottom blank 403 for at least partially forming a closed bottom or closed end 111 of the container 105 is illustrated.

As shown, the bottom blank 403 can have a configuration generally similar to that of the lid blank 303 described above, e.g., having the longitudinal axis L1 and the lateral axis L2, a central portion 407, and a marginal portion 409 extending to the peripheral edges of the bottom blank 403.

In the illustrated embodiment, the marginal portion 409 can be at least partially foldably connected to the central portion 407 at a generally rounded rectangular/elliptical fold line 410, though the blank 403 can be devoid of the fold line 410 without departing from the disclosure.

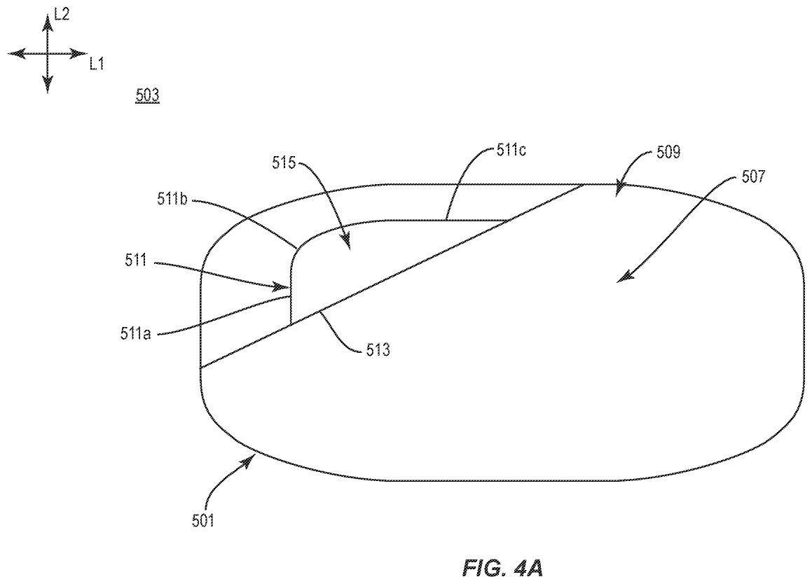

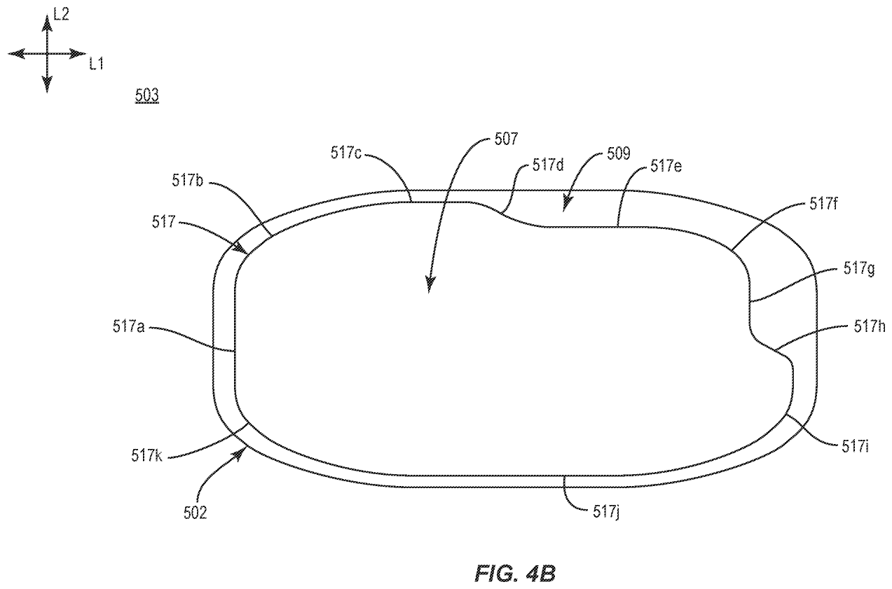

Turning to FIG. 4A, the exterior surface 501 of a barrier blank 503 for forming a barrier member 505 of the construct 105 is illustrated. With additional reference to FIG. 4B, the interior surface 502 of the barrier blank 503 and barrier member 505 formed therefrom is illustrated.

The barrier blank 503 can have the longitudinal axis L1 and the lateral axis L2, and can include a central portion 507 and a marginal portion 509 extending to the peripheral edges of the barrier blank 503. In some embodiments, the marginal portion 509 of the barrier blank 503 can be at least partially foldably connected to the central portion 507 at one or more lines of weakening, e.g., fold lines. In other embodiments, one or more foldable connections between the marginal portion 509 of the blank 503 and the central portion 507 of the blank 503 can be formed upon formation of the barrier member 505.

As shown in FIG. 4A, the marginal portion 509 of the blank 503 can be at least partially separable from the central portion 507 of the blank 503 and barrier member 505 formed therefrom at a curved line of weakening 511 (broadly, “first line of weakening”) and an oblique line of weakening 513. As shown, the line of weakening 511 can include a lateral segment 511a, a curved segment 511b, and a longitudinal segment 511c, each segment of the line of weakening 511 intersecting a respective adjacent segment of the line of weakening 511. In some embodiments, an access feature 515 can be at least partially defined in the central portion 507 by the line of weakening 511. In some embodiments, the access feature can be at least partially defined between the lines of weakening 511, 513.

Referring to FIG. 4B, the marginal portion 509 of the blank 503 and barrier member 505 formed therefrom can be at least partially defined by a line of weakening 517 (broadly, “second line of weakening”) that includes a first generally lateral segment 517a, a first curved upper segment 517b, a first generally longitudinal segment 517c, a second upper curved segment 517d, a second upper generally longitudinal segment 517e, a second upper curved segment 517f, a second generally lateral segment 517g, a medial curved segment 517h, a first lower curved segment 517i, a lower longitudinal segment 517j, and a second lower curved segment 517k. Each segment of the line of weakening 517 can intersect a respective adjacent segment of the line of weakening 517, though it will be understood that the line of weakening 517 can include one or more discontinuities without departing from the disclosure. In the illustrated embodiment, each segment of the line of weakening 517 can intersect a respective adjacent segment of the line of weakening 517.

In this regard, the exterior surface 501 of the blank 503 and barrier member 505 formed therefrom can have a different arrangement of lines of weakening than the interior surface 502 of the blank 503 and barrier member 505 formed therefrom. Such an arrangement can be accomplished, for example, by a precision die cut or other scoring/cutting/weakening process that forms the lines of weakening 511, 513 along the exterior surface 501 of the blank 503 partially, but not fully, through the thickness of the blank 503/barrier member 505, and the line of weakening 517 along the interior surface 502 of the blank 503 partially, but not fully, through the thickness of the blank 503/barrier member 505.

In this regard, one or both of the lines of weakening 511, 513 can be at least partially spaced away from the interior surface 502 of the barrier blank 503/barrier member 505, and the line of weakening 517 can be at least partially spaced away from the exterior surface 501 of the barrier blank 503/barrier member 505.

In some embodiments, the barrier blank 503 and barrier member 505 formed therefrom can be formed from one or more materials that can include aluminum foil, silicon-coated paper, plastic film, or laminates thereof. For example, in the illustrated embodiment, the barrier blank 503 can include at least a layer of paperboard material laminated with a layer of foil. In some embodiments, the barrier blank 503 and barrier member 505 formed therefrom can be formed of a paperboard material that is devoid of polymeric and/or metallic materials.

One or more of the blanks 203, 303, 403, 503 and one or more of the associated features thereof can have a different arrangement and/or configuration without departing from the disclosure. For example, and as described further herein, the body blank 203 can be formed into a body 205 of the container 105 with a generally rounded rectangular or elliptical vertical cross-section, with each of the blanks 303, 403, 503 having a corresponding cross-section for being at least partially received in the interior 107 of the container 105/body 205. In some embodiments, the body 205 can be formed with a different vertical cross-sectional configuration, and the blanks 303, 403, 503 can have a different configuration corresponding to such vertical cross-sectional configuration.

As described herein, the blanks 203, 303, 403, 503 can be further formed to provide components that assemble to form the container 105. In this regard, the blanks 203, 303, 403, 503 can be provided in combination for forming a system in the form of the container 105.

Turning to FIGS. 5A-5C, formation of the container 105 from the blanks 203, 303, 403, 503 will be described according to an exemplary embodiment of the disclosure.

The body blank 203 can be positioned to extend at least partially around an interior 107 of the container 105. In one embodiment, the body blank 203 can be at least partially bent, curved, folded, etc., for example, at the fold lines 223, into a generally elliptical or rounded rectangular cross-section, with portions of the body blank 203 proximate the free edges 207, 209 at least partially overlapped to form a seam arrangement, which can be maintained with a strip of adhesive tape T. In some embodiments, the free edges 207, 209 of the blank 203 can be brought into generally edge-to-edge contact.

The overlapping/meeting portions of the body blank 203 can be joined, for example, with an adhesive such as glue, with an adhesive coated tape or substrate, and/or through another method of joining such as ultrasonic welding, RF welding, interfering locking arrangements, etc.

As shown, the body 205 of the container 105 can thus be formed, with respective portions of the body forming portion 215 of the blank 203 forming a front wall or front panel 223, a first side wall or first side panel 225, a second side wall or second side panel 227, and a back wall or back panel 229. Respective curved corners 231, 233, 235, 237 can be formed between the respective panels 223, 225, the respective panels 223, 227, the respective panels 225, 229, and the respective panels 227, 229. In some embodiments, the blank 203 can be provided with one or more lines of weakening for facilitating such formation of rounded or curved corners of the body 205.

As described above, in some embodiments, the body 205 of the container 105 can be formed into a different cross-sectional configuration, e.g., circular, elliptical, triangular, rectangular, square, pentagonal, hexagonal, heptagonal, octagonal, etc., including rounded or curved corner variations thereof.

With continued reference to FIGS. 5A-5C, the closed bottom 111 of the container 105 can be formed, according to the illustrated embodiment, by positioning the bottom blank 403 in the interior 107 of the container 105, with the central portion 407 of the bottom blank 403 positioned in generally perpendicular relation with the panels 223, 225, 227, 229 so as to form a bottom panel 411 of the container 105. As shown, the bottom blank 403 can be positioned a vertical distance above the longitudinal free edge 213 of the blank 203.

The marginal portion 409 of the bottom blank 403 can be bent or folded downwardly relative to the central portion 407 of the blank 403/bottom panel 411, for example, at the fold line 410, and attached, e.g., adhered with an adhesive such as glue, welded, or otherwise attached, to the interior surface of one or more of the panels 223, 225, 227, 229 and corners 231, 233, 235, 237 of the body 205 of the container 105 so as to be engaged with the body 205 of the container 105.

Simultaneously or thereafter, the bottom forming portion 219 of the blank 203 can be bent/curled or folded, for example, at the fold lines 225, over the marginal portion 409 of the bottom blank 403 to form a bottom flange 113 of the container 105 that extends downwardly from the bottom panel 411. In some embodiments, the bottom forming portion 219 of the blank 203 can be crimped in such an arrangement. The bottom flange 113 can define a bottom edge 115 of the container 105.

With continued reference to FIGS. 5A-5C, the container 105 having the closed bottom 111 can be positioned, e.g., with the bottom flange 113 extending downwardly, supported on a surface such as a conveyor for being positioned below a filling station within which one or more articles

A can be deposited and held in the interior 107 of the container 105. In some embodiments, a container 105 can be supported in a generally stationary position and one or more filling devices can be brought into proximity with the container 105 for depositing articles A in the interior 107 of the container 105.

After filling the interior 107 of the container 105 with articles A, the barrier blank 603 can be positioned in the interior 107 of the container 105 above the articles A, with the central portion 507 of the barrier blank 503 positioned in generally perpendicular relation with the panels 223, 225, 227, 229. As shown, the barrier blank 503 can be positioned a vertical distance below the longitudinal free edge 211 of the blank 203/body 205.

In some embodiments, the barrier blank 503 can be inserted into the interior 107 of the container 105, formed into the barrier member 505, and/or attached to the body 205 of the container 105 via contact with a plunger or other moveable tool for positioning the blank 503/member 505.

In this regard, at least a portion of the marginal portion 509 of the blank 503/member 505 can be bent or folded upwardly relative to the central portion 507 of the barrier blank 503 and attached, e.g., adhered with an adhesive such as glue, welded, or otherwise attached, to the interior surface of one or more of the panels 223, 225, 227, 229 and corners 231, 233, 235, 237 of the body 205 of the container 105 to form the barrier member 505.

Following formation and positioning of the barrier member 505, the lid blank 303 can be positioned in the interior 107 of the container 105 above the barrier member 505. As shown, the lid blank 303 can be positioned a vertical distance below the longitudinal free edge 211.

The central portion 307 of the lid blank 303 can be positioned in generally perpendicular relation with the panels 223, 225, 227, 229 so as to form a lid panel 311 of the container 105.

The marginal portion 309 of the lid blank 303 can be bent or folded downwardly relative to the central portion 307 of the blank 303/lid panel 311, for example, at the fold line 310, and attached, e.g., adhered with an adhesive such as glue, welded, or otherwise attached, to the interior surface of one or more of the panels 223, 225, 227, 229 and corners 231, 233, 235, 237 of the body 205 of the container 105. It will be understood that the lines of weakening 313 can facilitate positioning of the marginal portion 309 relative to corners 231, 233, 235, 237.

Simultaneously or thereafter, the lid forming portion 217 of the blank 203 can be bent/curled or folded, for example, at the fold lines 225, over the marginal portion 309 of the lid blank 303 to form a lid collar or lid flange 119 of the lid 109 of the container 105 that is engaged with the body 205. In some embodiments, the lid forming portion 217 of the blank 203 can be crimped in such an arrangement. The lid flange 119 can define a top edge 121 of the lid 109/container 105.

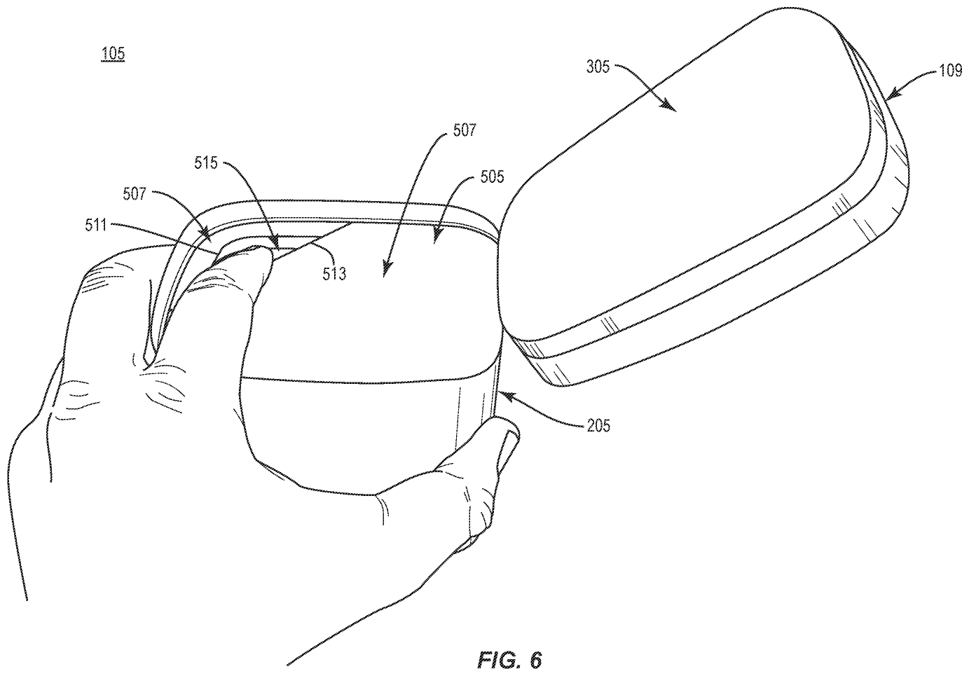

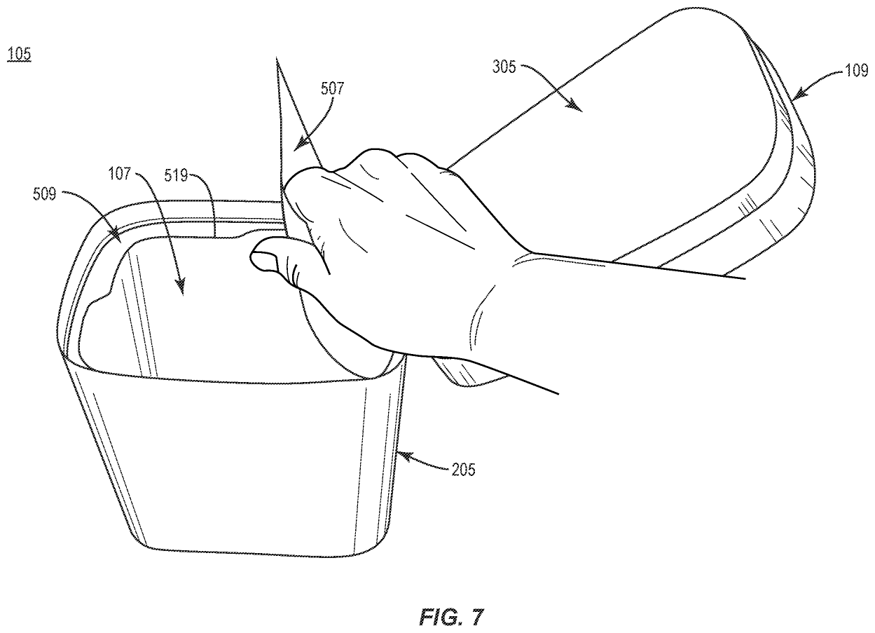

Turning to FIGS. 6 and 7, in order to access the interior 107 of the container 105, a user can separate the lid 109 from the body 205 of the container 105 along tear line segments of the line of weakening 221 and hingably/foldably move the lid 109 about a fold line segment of the line of weakening 221 to allow the lid 109 to be arranged in an open position, in which the lid 109 is moved away from the interior 107 of the container 105, and a closed position, in which the lid 109 at least partially overlies and/or is at least partially received in the interior 107 of the container 105.

When the lid 109 is in an open position, a user can remove the barrier member 505 to access articles A held therebeneath. In one embodiment, the user can press the barrier member 505 at the access feature 515 to facilitate at least partial separation of the central portion 507 from the marginal portion 509 of the barrier member 505 at the line of weakening 511 and the segments 517e, 517f, 517g of the line of weakening 517 therebelow. Movement of the access feature 515 can be at least partially facilitated by the line of weakening 513. In this regard, in some embodiments, the access feature 515 can be considered to be foldably connected to the central portion 507 of the barrier blank 503/barrier member 505 at the line of weakening 513.

Upon at least partial separation of the central portion 507 of the barrier member 505 a described above, a barrier opening 519 can be at least partially exposed through which a user can insert on or more of his or her fingers into the interior 107 of the container 105 below the barrier member 505 to engage the interior surface 502 of the barrier member 505 and pull the central portion 507 thereof upwardly to cause separation of the central portion 507 from the remainder of the marginal portion 509 along respective segments of the line of weakening 517. One or articles A in the interior 107 of the container 105 can thus be accessed through the barrier opening 519.

Due to the configuration of the barrier member 505 and the lines of weakening formed therealong, a relatively large opening to the lower portion of the interior 107 of the container 105 is provided upon separation of the central portion 507 of the barrier member 505 from the peripheral portion 509. Furthermore, the profile of the peripheral portion 509 of the barrier member 505 is minimized so as to substantially correspond to those portions attached to the body 205 of the container 105.

It will be understood that the reclosable lid 109 can be selectively repositioned from the open position to the closed position to reclose the container 105.

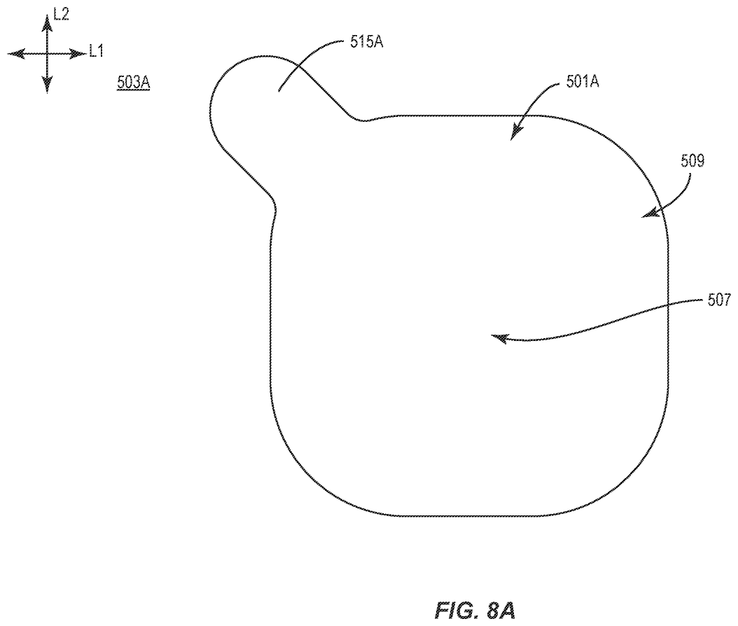

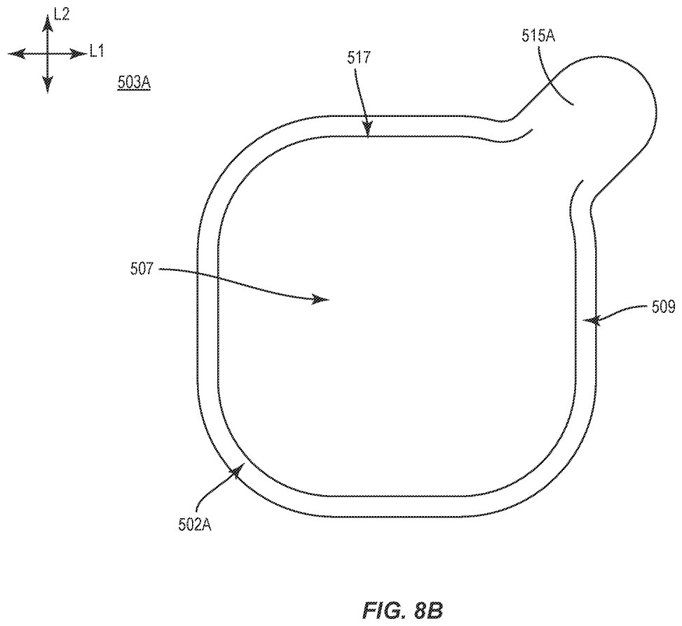

With additional reference to FIGS. 8A and 8B, the respective exterior surface 501A and interior surface 502A of a barrier blank 503A for forming a barrier member according to an alternative exemplary embodiment of the disclosure is illustrated.

The barrier blank 503A and barrier member formed therefrom can have a configuration generally similar to that described above with respect to the barrier blank 503 and barrier member 505 formed therefrom, and like or similar reference numerals are used to designate like or similar features.

As shown, the exterior surface 501A of the barrier blank 503A and barrier member formed therefrom can be devoid of the lines of weakening 511, 513, and can instead include an access feature in the form of a pull tab 515A extending or protruding away from the marginal portion 509 of the blank 503A and barrier member formed therefrom. As shown, the line of weakening 517 formed on the interior surface 502A of the barrier blank 503A and barrier member formed therefrom can have a generally square or rectangular configuration, and having endpoints that terminate proximate the pull tab 515A.

In this regard, a container can be formed that includes the barrier member formed from the blank 503A in place of the barrier member 505 described above. The central portion 507 of the barrier member formed from the blank 503A can be separated from the marginal portion 509 thereof by pulling on the pull tab 515A to provide functionality and advantages similar to those described above with respect to the barrier member 505.

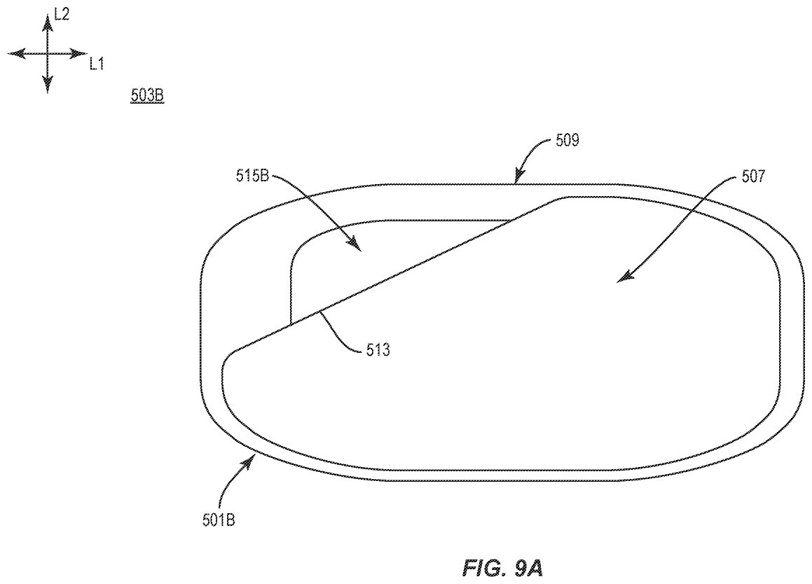

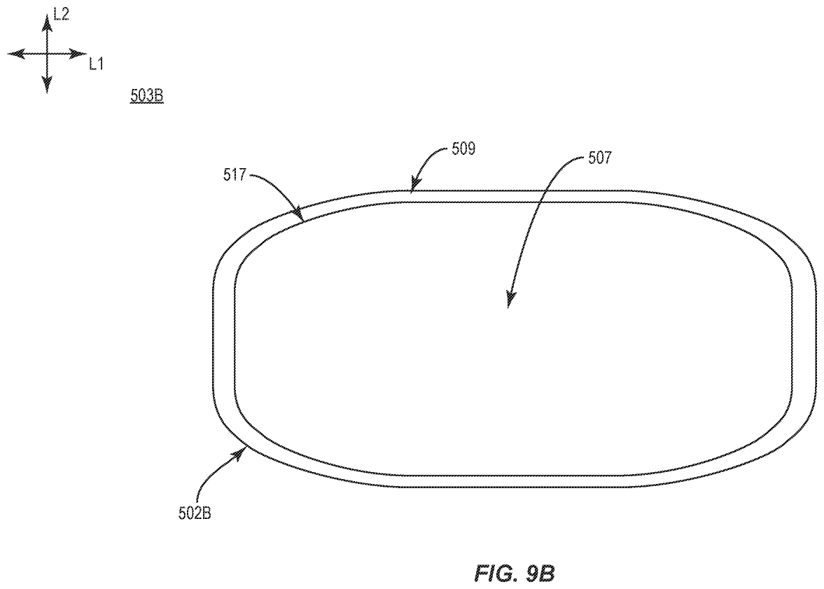

Turning to FIGS. 9A and 9B, the respective exterior surface 501B and interior surface 502B of a barrier blank 503B for forming a barrier member according to an alternative exemplary embodiment of the disclosure is illustrated.

The barrier blank 503B and barrier member formed therefrom can have a configuration generally similar to that described above with respect to the barrier blank 503 and barrier member 505 formed therefrom, and like or similar reference numerals are used to designate like or similar features.

As shown, the exterior surface 501B of the barrier blank 503B and barrier member formed therefrom can be devoid of the line of weakening 511 but can include the line of weakening 513 so as to form an access feature 515B. As shown, the line of weakening 517 formed on the interior surface 502B of the barrier blank 503B and barrier member formed therefrom can be generally similar to that described above with respect to the barrier blank 503/barrier member 505, except that the segments 517d, 517e, 517f, 517g, and 517h are instead a generally lateral mirror image of the segments 517c, 517b, and 517a.

In this regard, a container can be formed that includes the barrier member formed from the blank 503B in place of the barrier member 505 described above. The central portion 507 of the barrier member formed from the blank 503B can be separated from the marginal portion 509 thereof by pressing on the access feature 515B. In some embodiments, the central portion 507 of the barrier member formed from the blank 503B can be pressed downwardly into the interior 107 of the container 105 to provide access to articles A therebelow. Accordingly, the barrier member formed from the blank 503B can provide functionality and advantages similar to those described above with respect to the barrier member 505.

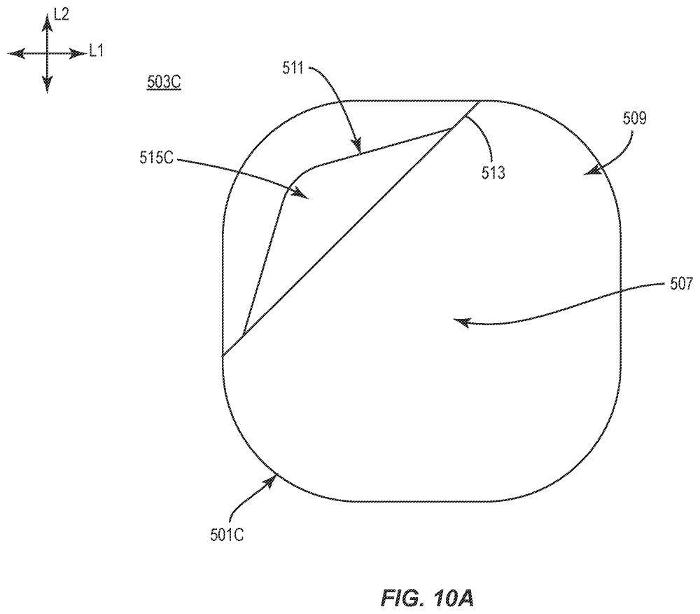

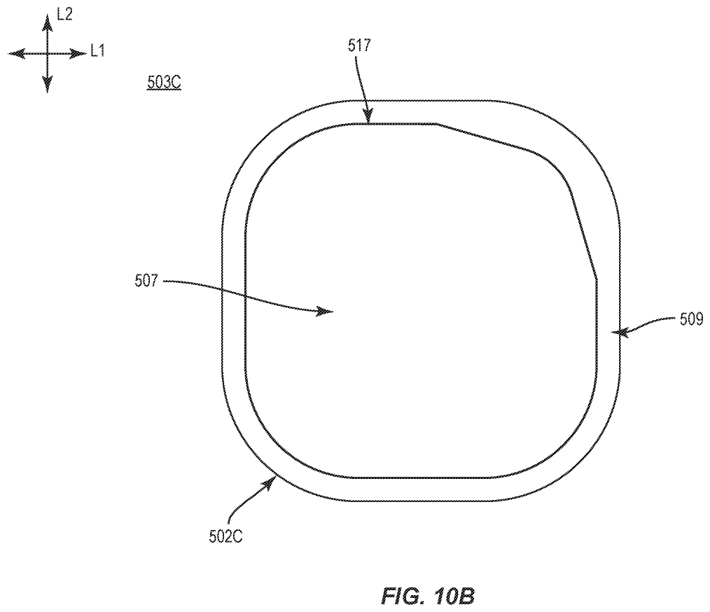

Turning to FIGS. 10A and 10B, the respective exterior surface 501C and interior surface 502C of a barrier blank 503C for forming a barrier member according to an alternative exemplary embodiment of the disclosure is illustrated.

The barrier blank 503B and barrier member formed there from can have a configuration generally similar to that described above with respect to the barrier blank 503 and barrier member 505 formed therefrom, and like or similar reference numerals are used to designate like or similar features.

As shown, the line of weakening 511 on the exterior surface 501C of the barrier blank 503C and barrier member formed therefrom can have the form of a generally pair of oblique segments intersecting a generally curved segment, as well as respective portions of the line of weakening 513. In this regard, an access feature 515C can be at least partially defined by the line of weakening 511. In some embodiments, the access feature 515C can be at least partially defined between the lines of weakening 511, 513.

As shown, the line of weakening 517 formed on the interior surface 502C of the barrier blank 503C and barrier member formed therefrom can have a generally square or rectangular configuration, and can intersect the respective segments of the line of weakening 511. In this regard, the line of weakening 511 can extend from the exterior surface 501C to the interior surface 501C of the barrier blank 503C and barrier member formed therefrom.

In this regard, a container can be formed that includes the barrier member formed from the blank 503C in place of the barrier member 505 described above. Accordingly, the barrier member formed from the blank 503C can provide functionality and advantages similar to those described above with respect to the barrier member 505.

It will be understood that the container 105 and/or one or more components thereof can have a different configuration without departing from the disclosure.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blanks. In accordance with the above-described embodiments, the blank may be constructed of paperboard of a caliper such that it is heavier and more rigid than ordinary paper. The blanks can also be constructed of other materials, such as cardboard, hard paper, or any other material having properties suitable for enabling the containers to function at least generally as described above. The blanks can also be laminated to or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type of tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line.

The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the spaced apart slits to be replaced with a continuous slit, a continuous score, or the like. For example, a cut line can be a continuous slit or could be wider than a slit without departing from the present disclosure. Also, a tear line can be a series of cut scores passing completely, or partially, through the material, that are separated by nicks.

The term “glue” is intended to encompass all manner of adhesives commonly used to secure container panels or portions in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A container for holding at least one article, the container comprising:
a body extending at least partially around an interior of the container;
a reclosable lid engaged with the body, the reclosable lid repositionable between an open position, in which the reclosable lid is moved away from the interior of the container, and a closed position, in which the reclosable lid at least partially overlies the interior of the container;
a closed bottom engaged with the body; and
a barrier member positioned in the interior of the container, the barrier member comprising a central portion at least partially separably connected to a marginal portion, the marginal portion attached to the body.

2. The container of claim 1, wherein the central portion of the barrier member is at least partially separable from the marginal portion of the barrier member for exposing a barrier opening for accessing at least one article in the interior of the container.

3. The container of claim 2, wherein the barrier member comprises an exterior surface and an interior surface, and the central portion of the barrier member is at least partially separable from the marginal portion of the barrier member at a first line of weakening at least partially defined in the exterior surface of the barrier member and a second line of weakening at least partially defined in the interior surface of the barrier member.

4. The container of claim 3, wherein the first line of weakening is at least partially spaced away from the interior surface of the barrier member and the second line of weakening is at least partially spaced away from the exterior surface of the barrier member.

5. The container of claim 4, wherein the second line of weakening comprises a first generally lateral segment, a first curved upper segment, a first generally longitudinal segment, a second upper curved segment, a second upper generally longitudinal segment, a second upper curved segment, a second generally lateral segment, a medial curved segment, a first lower curved segment, a lower longitudinal segment, and a second lower curved segment.

6. The container of claim 5, wherein each segment of the second line of weakening intersects a respective adjacent segment of the second line of weakening.

7. The container of claim 6, wherein the first line of weakening comprises a lateral segment, a curved segment, and a longitudinal segment.

8. The container of claim 7, wherein each segment of the second line of weakening intersects a respective adjacent segment of the second line of weakening.

9. The container of claim 3, wherein the barrier member comprises an access feature for facilitating at least partial separation of the central portion from the marginal portion of the barrier member.

10. The container of claim 9, wherein the access feature is at least partially defined by the first line of weakening.

11. The container of claim 10, wherein the access feature is foldably connected to the central portion of the barrier member.

12. The container of claim 9, wherein the access feature protrudes away from the marginal portion of the barrier member.

13. A combination of blanks for forming a container for holding at least one article, the combination of blanks comprising:
a body blank for forming a body extending at least partially around an interior of the container formed from the combination of blanks;
a lid blank for forming reclosable lid engaged with the body when the container is formed from the combination of blanks such that the reclosable lid repositionable between an open position, in which the reclosable lid is moved away from the interior of the container formed from the combination of blanks, and a closed position, in which the reclosable lid at least partially overlies the interior of the container formed from the combination of blanks;
a bottom blank for forming a closed bottom engaged with the body of the container formed from the combination of blanks; and
a barrier blank positioned in the interior of the container formed from the combination of blanks, the barrier blank comprising a central portion at least partially separably connected to a marginal portion, the marginal portion for being attached to the body of the container formed from the combination of blanks.

14. The combination of claim 13, wherein the central portion of the barrier blank is at least partially separable from the marginal portion of the barrier blank for exposing a barrier opening for accessing at least one article in the interior of the container formed from the combination of blanks.

15. The combination of claim 14, wherein the barrier blank comprises an exterior surface and an interior surface, and the central portion of the barrier blank is at least partially separable from the marginal portion of the barrier blank at a first line of weakening at least partially defined in the exterior surface of the barrier blank and a second line of weakening at least partially defined in the interior surface of the barrier blank.

16. The combination of claim 15, wherein the first line of weakening is at least partially spaced away from the interior surface of the barrier blank and the second line of weakening is at least partially spaced away from the exterior surface of the barrier blank.

17. The combination of claim 16, wherein the second line of weakening comprises a first generally lateral segment, a first curved upper segment, a first generally longitudinal segment, a second upper curved segment, a second upper generally longitudinal segment, a second upper curved segment, a second generally lateral segment, a medial curved segment, a first lower curved segment, a lower longitudinal segment, and a second lower curved segment.

18. The combination of claim 17, wherein each segment of the second line of weakening intersects a respective adjacent segment of the second line of weakening.

19. The combination of claim 18, wherein the first line of weakening comprises a lateral segment, a curved segment, and a longitudinal segment.

20. The combination of claim 19, wherein each segment of the second line of weakening intersects a respective adjacent segment of the second line of weakening.

21. The combination of claim 15, wherein the barrier blank comprises an access feature for facilitating at least partial separation of the central portion from the marginal portion when the container is formed from the combination of blanks.

22. The combination of claim 21, wherein the access feature is at least partially defined by the first line of weakening.

23. The combination of claim 22, wherein the access feature is foldably connected to the central portion of the barrier blank.

24. The combination of claim 21, wherein the access feature protrudes away from the marginal portion of the barrier blank.

25. A method of forming a container for holding at least one article, the method comprising:
obtaining a body blank;
obtaining a lid blank;
obtaining a bottom blank;
obtaining a barrier blank, the barrier blank comprising a central portion at least partially separably connected to a marginal portion;
forming a body of the container from the body blank such that the body extends at least partially around an interior of the container;
forming a reclosable lid from the lid blank such that the reclosable lid is engaged with the body, the reclosable lid repositionable between an open position, in which the reclosable lid is moved away from the interior of the container, and a closed position, in which the reclosable lid at least partially overlies the interior of the container;
forming a closed bottom from the bottom blank such that the closed bottom is engaged with the body of the container; and
attaching the marginal portion of the barrier blank to the body of the container to form a barrier member.

26. The method of claim 25, wherein the central portion of the barrier member is at least partially separable from the marginal portion of the barrier member for exposing a barrier opening for accessing at least one article in the interior of the container.

27. The method of claim 26, wherein the barrier member comprises an exterior surface and an interior surface, and the central portion of the barrier member is at least partially separable from the marginal portion of the barrier member at a first line of weakening at least partially defined in the exterior surface of the barrier member and a second line of weakening at least partially defined in the interior surface of the barrier member.

28. The method of claim 27, wherein the first line of weakening is at least partially spaced away from the interior surface of the barrier member and the second line of weakening is at least partially spaced away from the exterior surface of the barrier member.

29. The method of claim 28, wherein the second line of weakening comprises a first generally lateral segment, a first curved upper segment, a first generally longitudinal segment, a second upper curved segment, a second upper generally longitudinal segment, a second upper curved segment, a second generally lateral segment, a medial curved segment, a first lower curved segment, a lower longitudinal segment, and a second lower curved segment.

30. The method of claim 29, wherein each segment of the second line of weakening intersects a respective adjacent segment of the second line of weakening.

31. The method of claim 30, wherein the first line of weakening comprises a lateral segment, a curved segment, and a longitudinal segment.

32. The method of claim 31, wherein each segment of the second line of weakening intersects a respective adjacent segment of the second line of weakening.

33. The method of claim 27, wherein the barrier member comprises an access feature for facilitating at least partial separation of the central portion from the marginal portion of the barrier member.

34. The method of claim 33, wherein the access feature is at least partially defined by the first line of weakening.

35. The method of claim 34, wherein the access feature is foldably connected to the central portion of the barrier member.

36. The method of claim 33, wherein the access feature protrudes away from the marginal portion of the barrier member.
